(19) United States
(12) Patent Application Publication
(10) Pub. No.: US 2014/0351134 A1
(43) Pub. Date: Nov. 27, 2014

(54) REGISTRATION PROCESS

(71) Applicant: Pop! Online, LLC, Miami, FL (US)

(72) Inventor: ERIC BROWN, Miami, FL (US)

(73) Assignee: Pop! Online, LLC, Miami, FL (US)

(21) Appl. No.: 14/284,098

(22) Filed: May 21, 2014

Related U.S. Application Data
(60) Provisional application No. 61/825,743, filed on May 21, 2013.

(51) Int. Cl. G06Q 20/40

(52) U.S. Cl. CPC G06Q 20/4014
USPC 705/44

(57) ABSTRACT

A method, computer program product, and computing system for defining a domain name for purchase. A purchaser for the domain name is defined. A cell phone number for the purchaser is defined. The authenticity of the purchaser is confirmed based, at least in part, upon SMS messaging. An online presence is automatically generated at the domain name.

### RELATED APPLICATION

This application claims the benefit of U.S. Provisional Patent Application No. 61/825,743, filed on 21 May 2013, and entitled “System and Method for Establishing an Online Presence”, the entire disclosure of which is incorporated herein by reference.

### TECHNICAL FIELD

This disclosure relates to domain registration systems and, more particularly, to automated domain registration systems.

### BACKGROUND

Setting up an online presence may be a daunting task when the person is not very experienced with doing the same. Accordingly, numerous discrete tasks may need to be performed in the appropriate sequence in order for the overall operation to be successful. For example, a domain name must be secured and a hosting server must be identified. And then a webpage must be generated and email accounts must be established.

Accordingly, the person performing the operation must be skilled in numerous tasks, all of which are quite different than each other. Further, in the event that any of the discrete tasks are unsuccessful, the overall operation may be a failure.

### SUMMARY OF DISCLOSURE

In one implementation, a computer-implemented method includes defining a domain name for purchase. A purchaser for the domain name is defined. A cell phone number for the purchaser is defined. The authenticity of the purchaser is confirmed based, at least in part, upon SMS messaging. An online presence is automatically generated at the domain name.

One or more of the following features may be included. Confirming the authenticity of the purchaser may include providing a confirmation text message to the cell phone number. The confirmation text message may include confirmation information. Confirming the authenticity of the purchaser may further include receiving a confirmation response that includes the confirmation information. If the domain name is available for purchase may be determined. Defining a purchaser for the domain name may include defining a first name and a last name for the purchaser. Automatically generating an online presence at the domain name may include generating a webpage at the domain name and defining at least one email address for the domain name.

In another implementation, a computer program product resides on a computer readable medium and has a plurality of instructions stored on it. When executed by a processor, the instructions cause the processor to perform including defining a domain name for purchase. A purchaser for the domain name is defined. A cell phone number for the purchaser is defined. The authenticity of the purchaser is confirmed based, at least in part, upon SMS messaging. An online presence is automatically generated at the domain name.

One or more of the following features may be included. Confirming the authenticity of the purchaser may include providing a confirmation text message to the cell phone number. The confirmation text message may include confirmation information. Confirming the authenticity of the purchaser may further include receiving a confirmation response that includes the confirmation information. If the domain name is available for purchase may be determined. Defining a purchaser for the domain name may include defining a first name and a last name for the purchaser. Automatically generating an online presence at the domain name may include generating a webpage at the domain name and defining at least one email address for the domain name.

In another implementation, a computing system including a processor and memory is configured to perform operations including defining a domain name for purchase. A purchaser for the domain name is defined. A cell phone number for the purchaser is defined. The authenticity of the purchaser is confirmed based, at least in part, upon SMS messaging. An online presence is automatically generated at the domain name.

One or more of the following features may be included. Confirming the authenticity of the purchaser may include providing a confirmation text message to the cell phone number. The confirmation text message may include confirmation information. Confirming the authenticity of the purchaser may further include receiving a confirmation response that includes the confirmation information. If the domain name is available for purchase may be determined. Defining a purchaser for the domain name may include defining a first name and a last name for the purchaser. Automatically generating an online presence at the domain name may include generating a webpage at the domain name and defining at least one email address for the domain name.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a registration process according to an implementation of the present disclosure;

FIG. 2A is a flowchart of a first portion of the registration process of FIG. 1 according to an implementation of the present disclosure;

FIG. 2B is a flowchart of a second portion of the registration process of FIG. 1 according to an implementation of the present disclosure;

FIG. 3A is a diagrammatic view of a user interface generated by the registration process of FIG. 1 according to an implementation of the present disclosure;

FIG. 3B is a diagrammatic view of a user interface generated by the registration process of FIG. 1 according to an implementation of the present disclosure;

FIG. 3C is a diagrammatic view of a user interface generated by the registration process of FIG. 1 according to an implementation of the present disclosure;

FIG. 3D is a diagrammatic view of a user interface generated by the registration process of FIG. 1 according to an implementation of the present disclosure;

FIG. 3E is a diagrammatic view of a user interface generated by the registration process of FIG. 1 according to an implementation of the present disclosure;

FIG. 3F is a diagrammatic view of a user interface generated by the registration process of FIG. 1 according to an implementation of the present disclosure;

FIG. 3G is a diagrammatic view of a user interface generated by the registration process of FIG. 1 according to an implementation of the present disclosure;

FIG. 3H is a diagrammatic view of a user interface generated by the registration process of FIG. 1 according to an implementation of the present disclosure; and

FIG. 3I is a diagrammatic view of a user interface generated by the registration process of FIG. 1 according to an implementation of the present disclosure.

Like reference symbols in the various drawings indicate like elements.

### DETAILED DESCRIPTION OF THE PREFERRED EMBODIMENTS

### System Overview

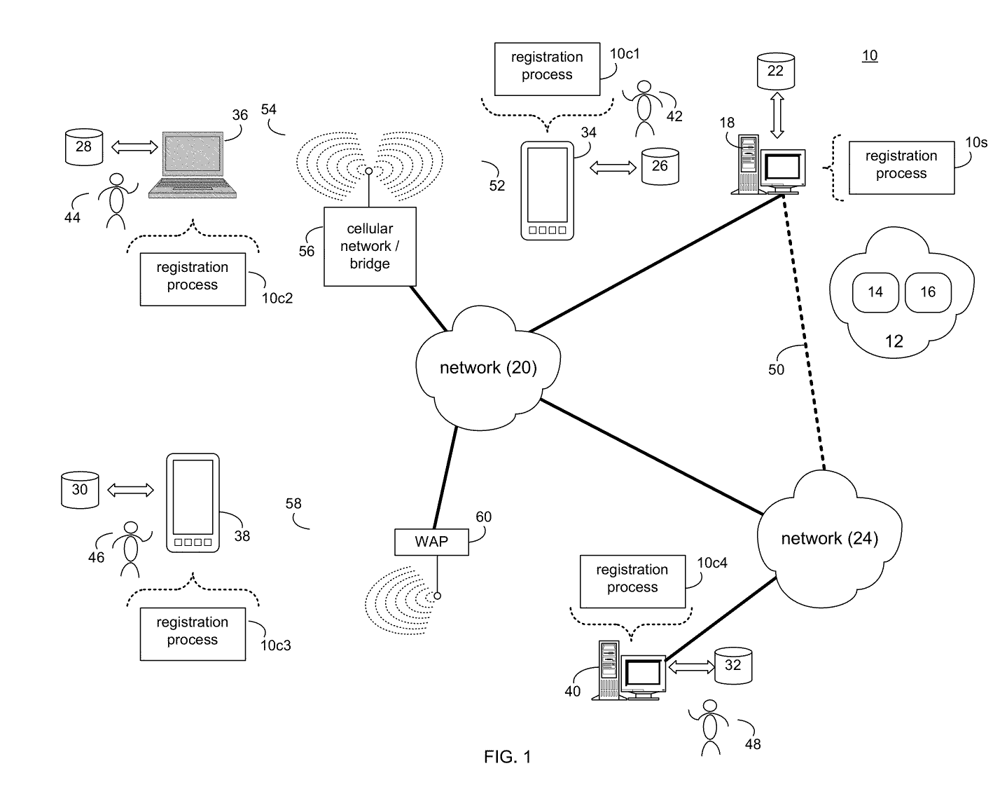

In FIG. 1, there is shown registration process 10. As will be discussed below in greater detail, registration process 10 may be utilized to automatically generate online presence 12, wherein online presence 12 may include webpage 14 and email address(es) 16.

Registration process 10 may be implemented as a server-side process, a client-side process, or a hybrid server-side/client-side process. For example, registration process 10 may be implemented as a purely server-side process via registration process 10s. Alternatively, registration process 10 may be implemented as a purely client-side process via one or more of client-side application 10c1, client-side application 10c2, client-side application 10c3, and client-side application 10c4. Alternatively still, registration process 10 may be implemented as a hybrid server-side/client-side process via registration process 10s in combination with one or more of client-side application 10c1, client-side application 10c2, client-side application 10c3, and client-side application 10c4. Accordingly, registration process 10 as used in this disclosure may include any combination of registration process 10s, client-side application 10c1, client-side application 10c2, client-side application 10c3, and client-side application 10c4.

Registration process 10s may be a server application and may reside on and may be executed by computing device 18, which may be connected to network 20 (e.g., the Internet or a local area network). Examples of computing device 18 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of registration process 10s, which may be stored on storage device 22 coupled to computing device 18, may be executed by one or more processors (not shown) and one or more memory architectures (not shown) included within computing device 18. Examples of storage device 22 may include but are not limited to: a hard disk drive; a tape drive; an optical drive; a RAID device; a random access memory (RAM); a read-only memory (ROM); and all forms of flash memory storage devices.

Network 20 may be connected to one or more secondary networks (e.g., network 24), examples of which may include but are not limited to: a local area network; a wide area network; or an intranet, for example.

Examples of client-side applications 10c1, 10c2, 10c3, 10c4 may include but are not limited to a web browser, a game console user interface, or a specialized application (e.g., an application running on e.g., the Android™ platform or the iPhone™ platform). The instruction sets and subroutines of client-side applications 10c1, 10c2, 10c3, 10c4, which may be stored on storage devices 26, 28, 30, 32 (respectively) coupled to client electronic devices 34, 36, 38, 40 (respectively), may be executed by one or more processors (not shown) and one or more memory architectures (not shown) incorporated into client electronic devices 34, 36, 38, 40 (respectively). Examples of storage devices 26, 28, 30, 32 may include but are not limited to: hard disk drives; tape drives; optical drives; RAID devices; random access memories (RAM); read-only memories (ROM), and all forms of flash memory storage devices.

Examples of client electronic devices 34, 36, 38, 40 may include, but are not limited to, data-enabled, cellular telephone 34, laptop computer 36, personal digital assistant 38, personal computer 40, a notebook computer (not shown), a server computer (not shown), a gaming console (not shown), a smart television (not shown), and a dedicated network device (not shown). Client electronic devices 34, 36, 38, 40 may each execute an operating system, examples of which may include but are not limited to Microsoft Windows™, Android™, WebOS™, iOS™, Redhat Linux™, or a custom operating system.

Users 42, 44, 46, 48 may access registration process 10 directly through network 20 or through secondary network 24. Further, registration process 10 may be connected to network 20 through secondary network 24, as illustrated with link line 50.

The various client electronic devices (e.g., client electronic devices 34, 36, 38, 40) may be directly or indirectly coupled to network 20 (or network 24). For example, data-enabled, cellular telephone 34 and laptop computer 36 are shown wirelessly coupled to network 20 via wireless communication channels 52, 54 (respectively) established between data-enabled, cellular telephone 34, laptop computer 36 (respectively) and cellular network/bridge 56, which is shown directly coupled to network 20. Further, personal digital assistant 38 is shown wirelessly coupled to network 20 via wireless communication channel 58 established between personal digital assistant 38 and wireless access point (i.e., WAP) 60, which is shown directly coupled to network 20. Additionally, personal computer 40 is shown directly coupled to network 24 via a hardwired network connection.

WAP 60 may be, for example, an IEEE 802.11a, 802.11b, 802.11g, 802.11n, Wi-Fi, and/or Bluetooth device that is capable of establishing wireless communication channel 58 between personal digital assistant 38 and WAP 60. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Registration Process:

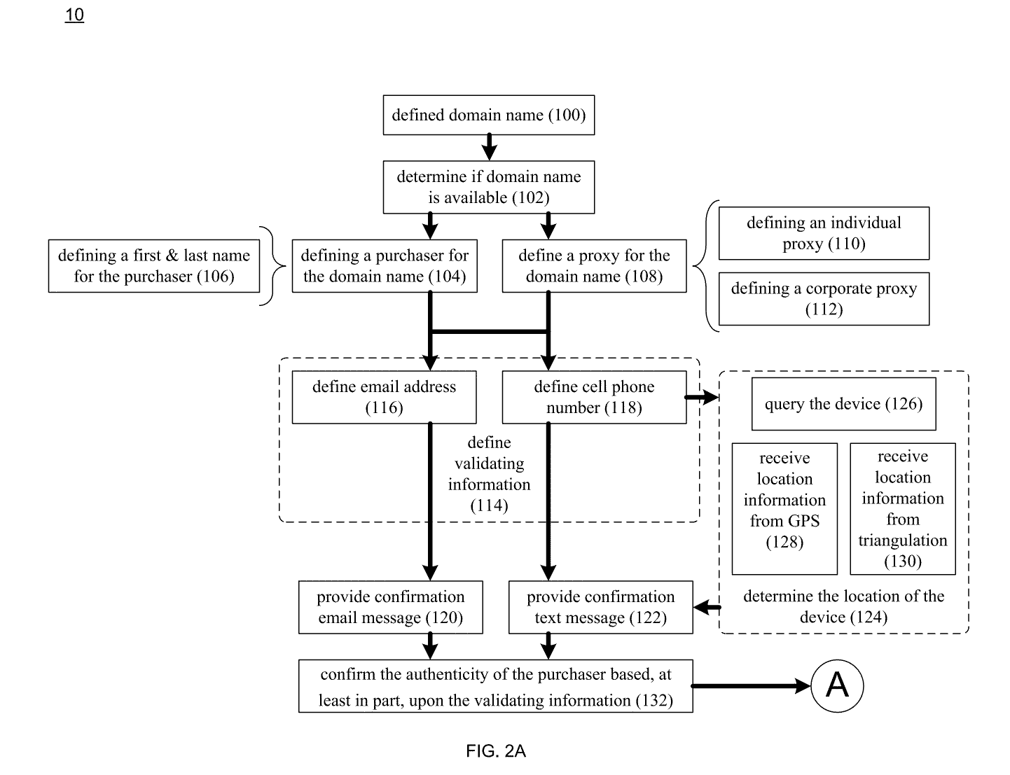

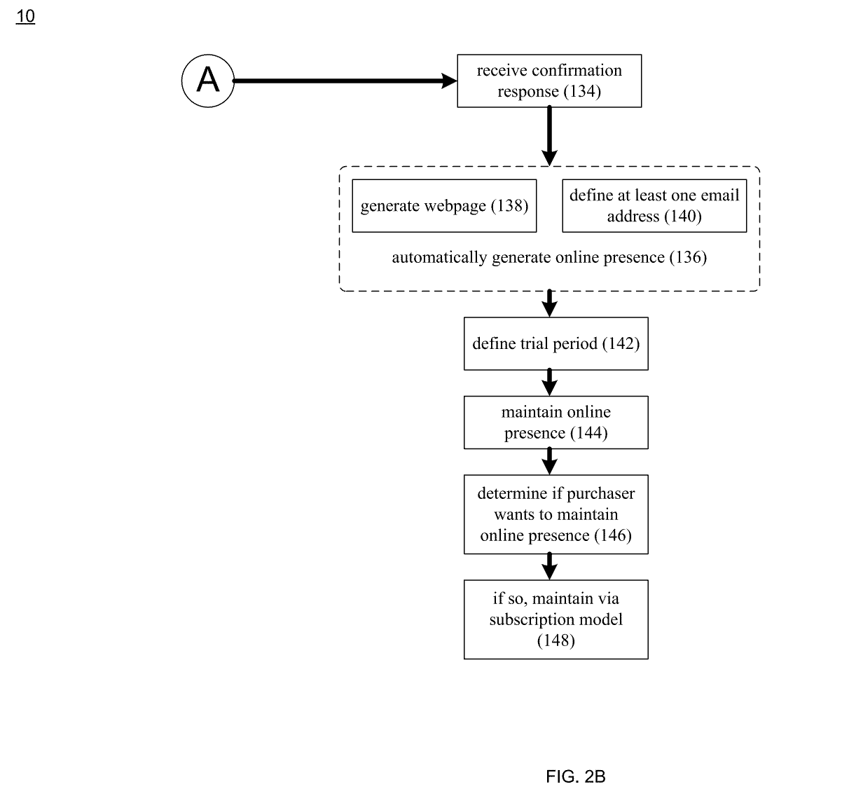

Referring also to FIGS. 2A-2B, assume for illustrative purpose that user 42 wishes to create online presence 12. Further, assume that user 42 assesses registration process 10 using client electronic device 34.

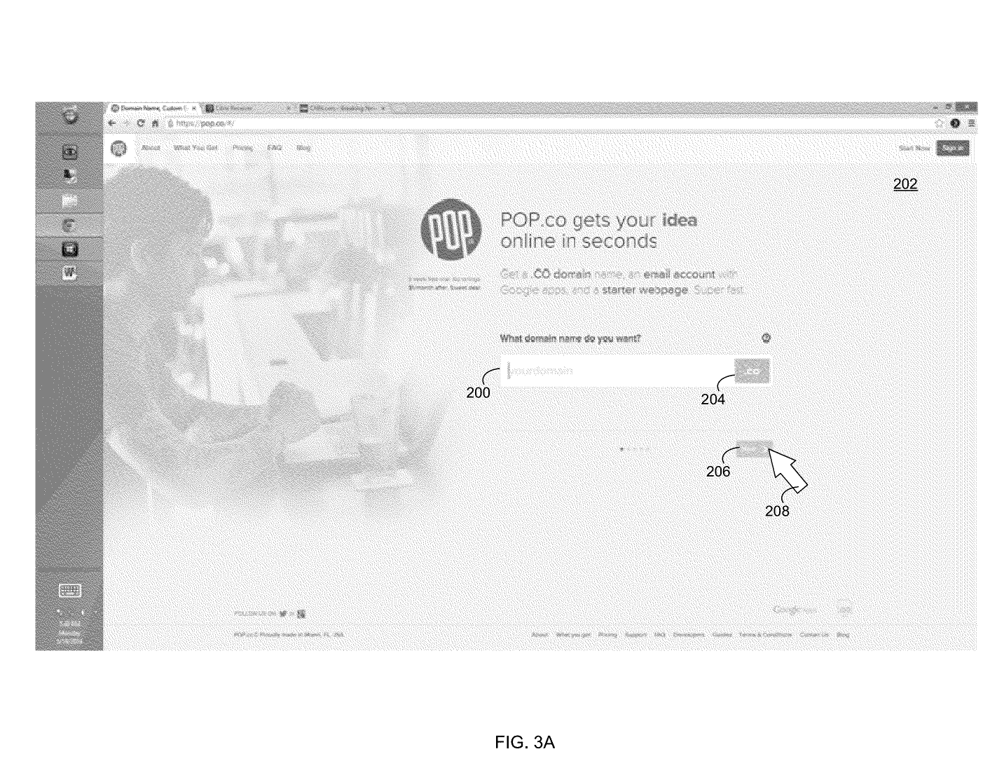

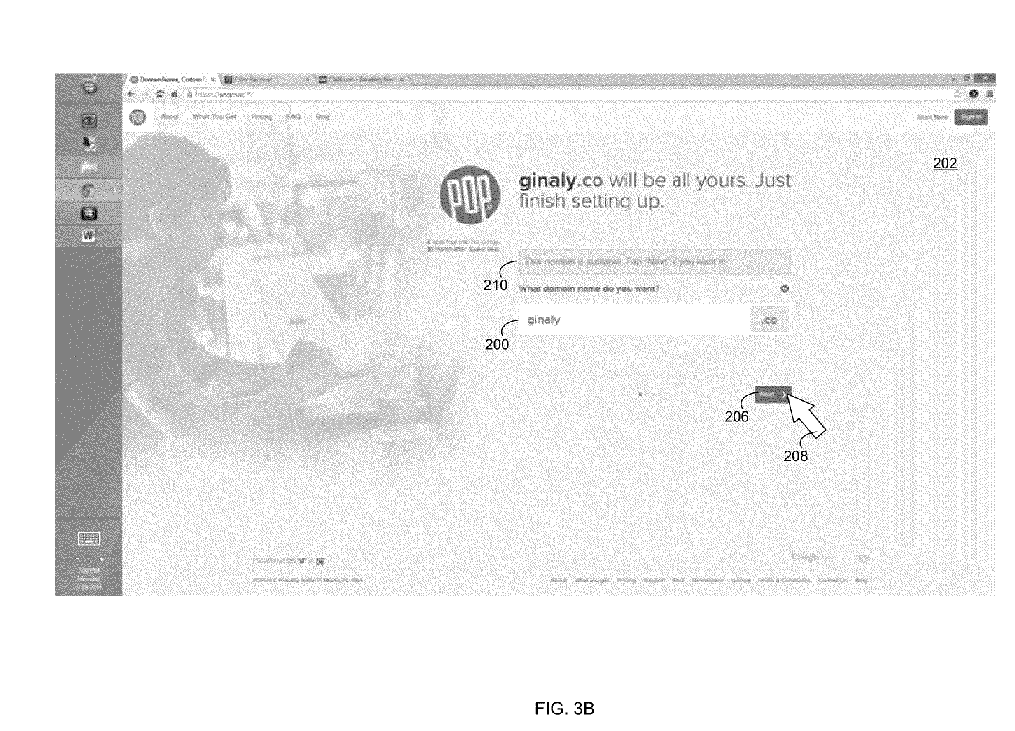

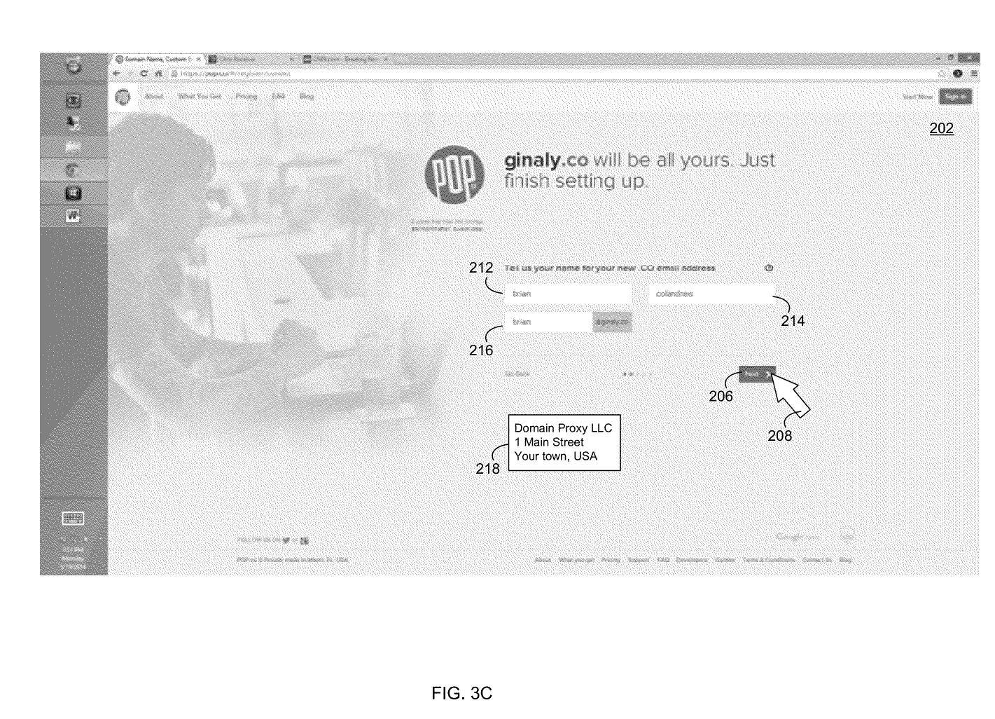

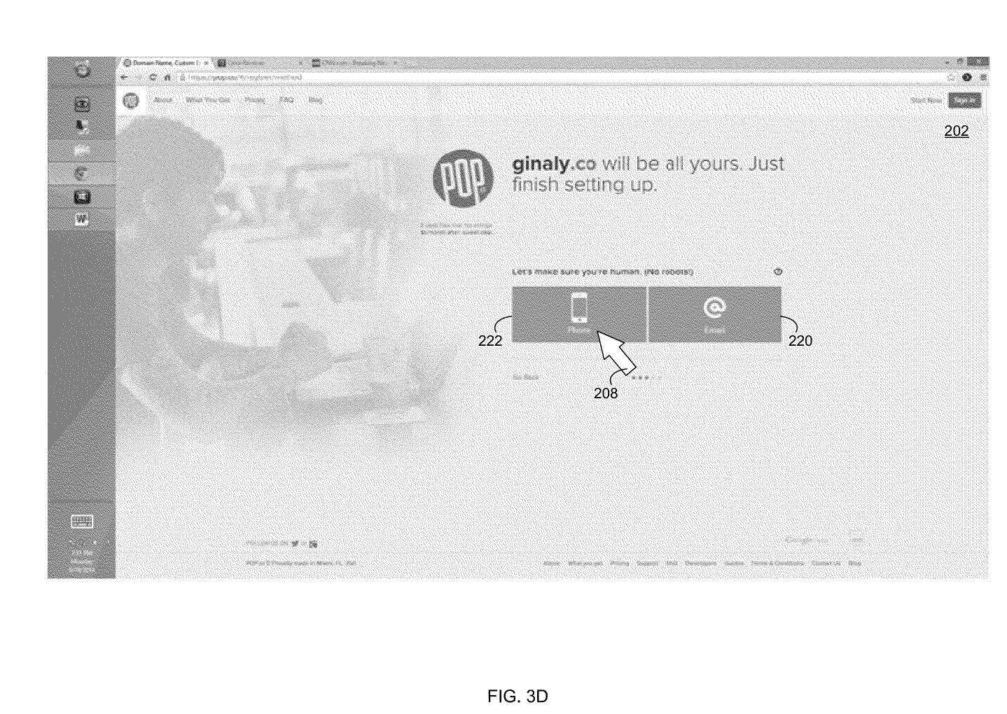

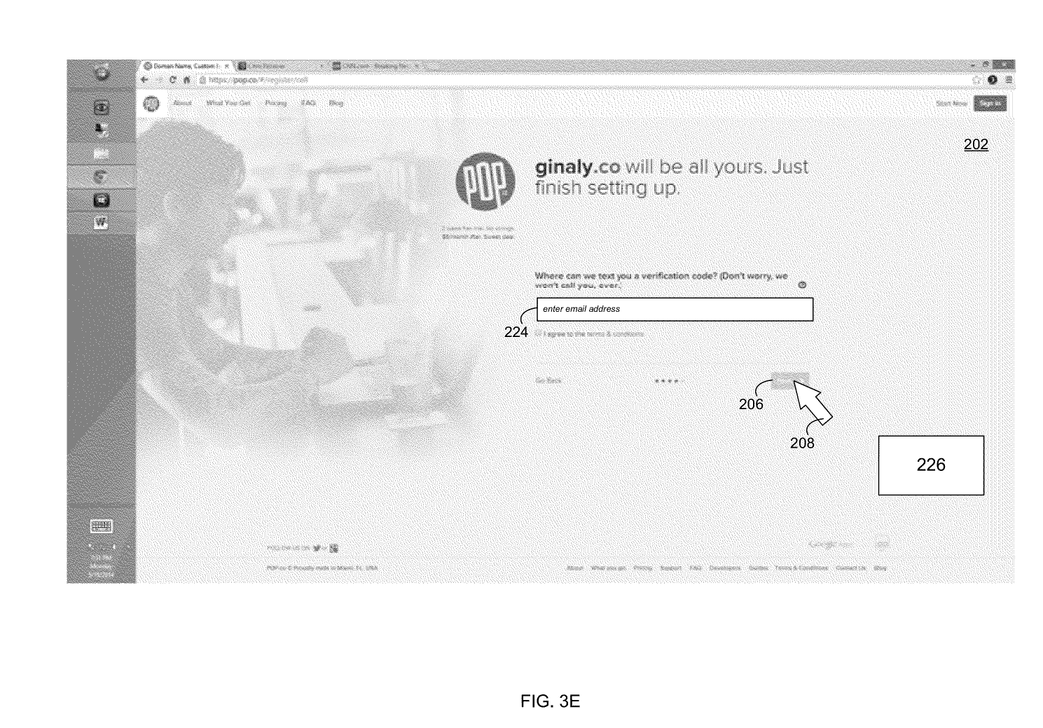

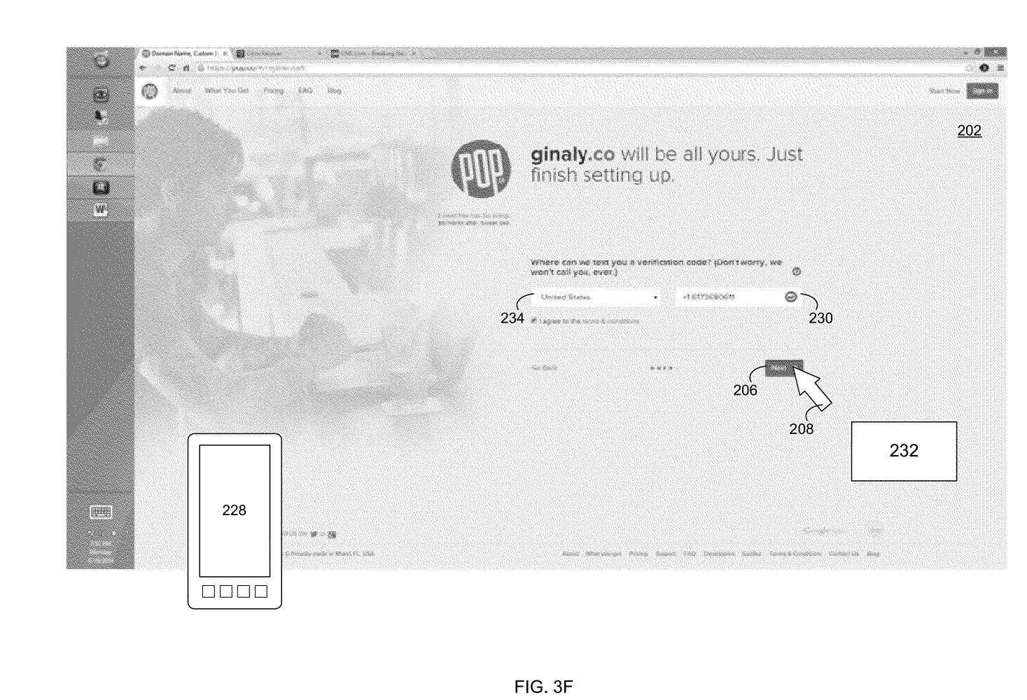

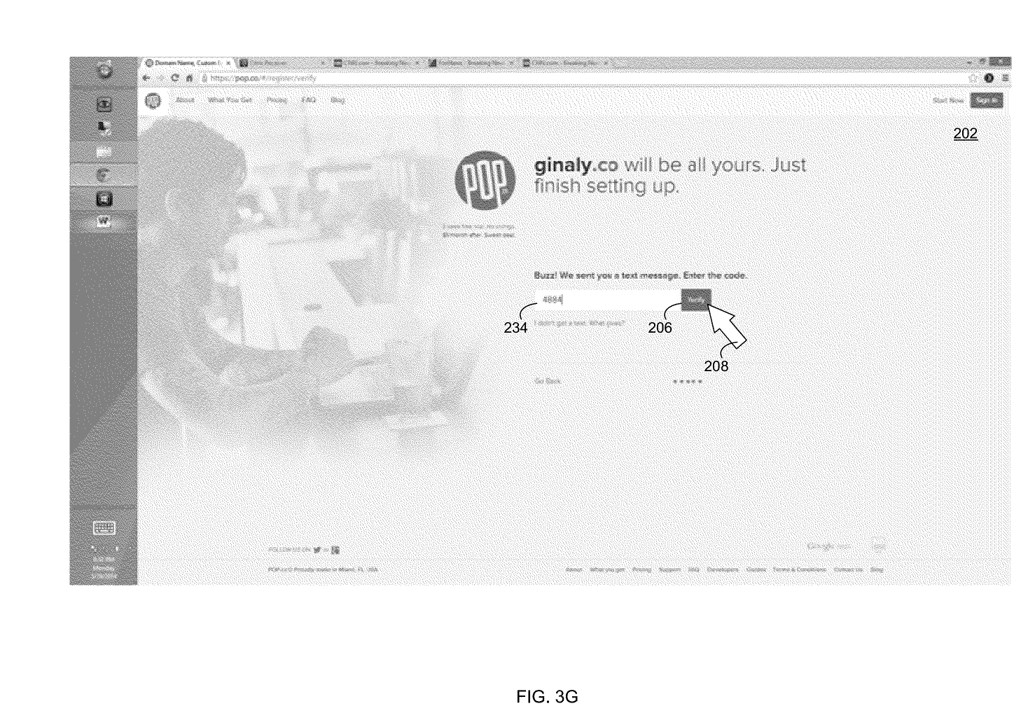

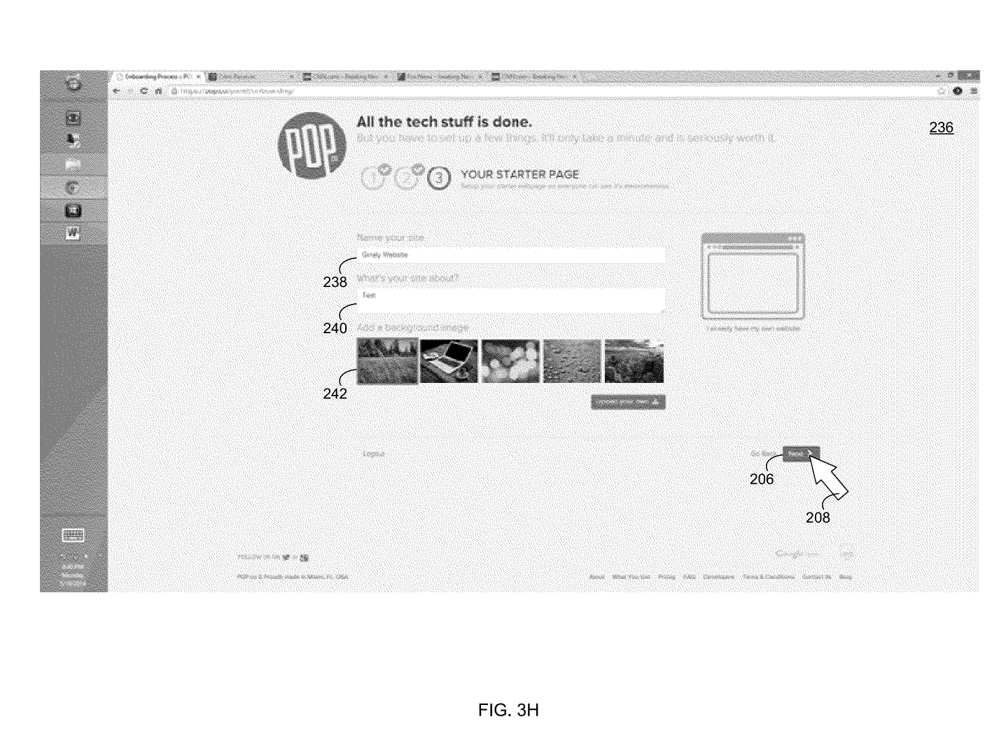

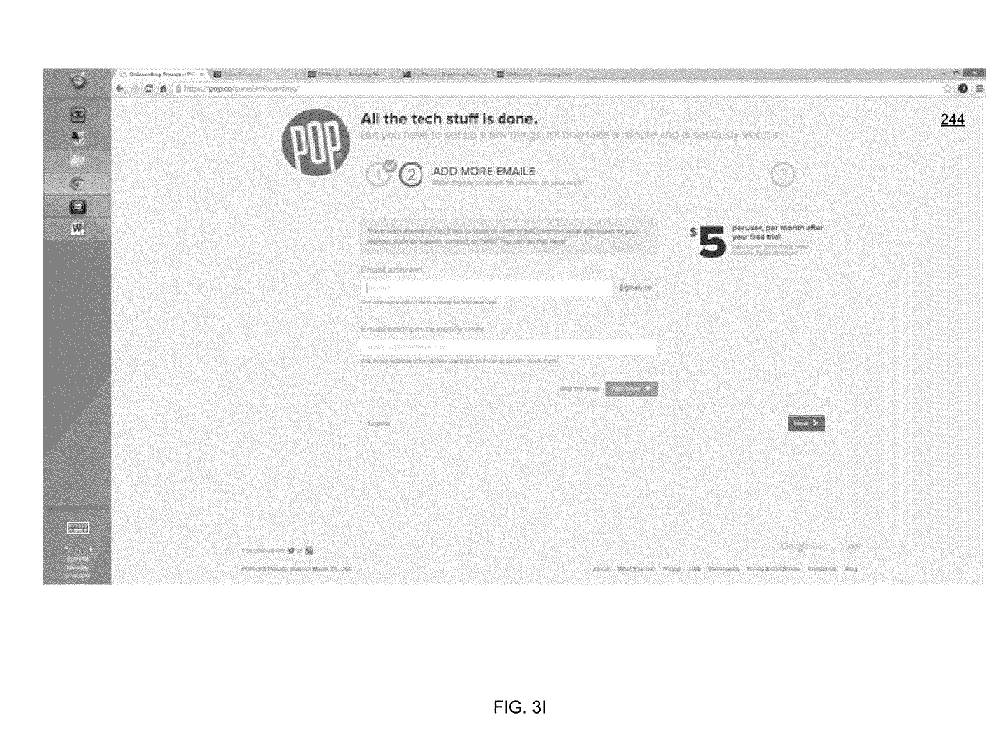

Accordingly, user 42 may define 100 the domain name that they are interested in purchasing. For illustrative purposes, assume the domain name that user 42 is interested in purchasing is “ginaly”. Therefore, user 42 may define 100 the domain name “ginaly” within domain field 200 of user interface 202 rendered by registration process 10 (as shown in FIG. 3A). Additionally, user 42 may also define (within TLD field 204 of user interface 202) the top level domain with which their domain name (e.g., ginaly) should be associated. For illustrative purposes, assume that user 42 is interested in the top level domain “.co”.

Once domain field 200 defines 100 the domain name (e.g., ginaly) and TLD field 204 defines the top level domain (e.g., .com), user 42 may select next button 206. The manner in which next button 206 is selected may vary depending upon the type of client electronic device utilized by user 42. For example, if the client electronic device is a touch-enabled client electronic device, user 42 may simply select next button 206 with their finger. Alternatively, if the client electronic device utilized by user 42 is not touch-enabled, user 42 may select next button 206 with onscreen pointer 208 (controllable by e.g., a mouse; not shown).

Once defined 100, registration process 10 may determine 102 if the domain name (e.g., ginaly) requested is available for purchase. If the domain name requested is available for purchase, user interface 202 rendered by registration process 10 may provide user 42 with an indication of the same (as shown in FIG. 3B). An example of such an indication is status field 210 of user interface 202, which (in this example) informs user 42 that the domain name (e.g., ginaly) requested is available for purchase. If the domain name (e.g., ginaly) requested is not available for purchase, status field 210 of user interface 202 may display the appropriate message. Further, registration process 10 may be configured to allow the user to select an alternate domain name. Additionally, registration process 10 may be configured to provide one or more suggestions of similar domain names that are available for purchase.

Once a determination 102 is made concerning the availability of the domain name requested (e.g., ginaly), registration process 10 may define 104 a purchaser for the domain name (as shown in FIG. 3C). For example, user 42 may define 106 the first name of the purchaser within first name field 212 and may define 106 the last name of the purchaser within last name field 214. Additionally, user 42 may define an email address within email field 216 that is to be associated with the purchaser of the domain name requested (e.g., ginaly).

Once first name field 212 defines 106 the first name of the purchaser, last name field 214 defines 106 the last name of the purchaser, and email field 216 defines an email address to be associated with the purchaser, user 42 may select next button 206.

Instead of requiring (in this example) user 42 to define 104 a purchaser for the domain name requested (e.g., ginaly), registration process 10 may be configured to define 108 a proxy for the domain name requested (e.g., ginaly). For example, if user 42 does not wish to disclose their name as the soon-to-be owner of the domain name requested (e.g., ginaly), registration process 10 may be configured to allow user 42 to define 108 a proxy for the domain name. For example and through registration process 10, user 42 may define 110 an individual proxy (e.g., John Smith) for the domain name requested. When defining 110 an individual proxy, registration process 10 may be configured to allow user 42 to define the individual proxy within the above-described first name field 212 and second name field 214. Additionally/alternatively and through registration process 10, user 42 may define 112 a corporate proxy (e.g., Domain Proxy LLC) for the domain name requested. When defining 112 a corporate proxy, registration process 10 may be configured to allow user 42 to define the corporate proxy within corporate proxy field 218.

Once the purchaser of the domain name requested (e.g., ginaly) is defined within fields 212, 214, the individual proxy of the domain name requested (e.g., ginaly) is defined within fields 212, 214, or the corporate proxy of the domain name requested (e.g., ginaly) is defined within corporate proxy field 218, user 42 may select next button 206.

Once a purchaser is defined 104 (or a proxy is defined 108), registration process 10 may define 114 validating information for the purchaser (as shown in FIG. 3D). Examples of such validating information may include but are not limited to a cell phone number and an email address. In the event that user 42 wishes to define 116 validating information in the form of an email address, user 42 may select email button 220. In the event that user 42 wishes to define 118 validating information in the form of a cell phone number, user 42 may select cell phone button 222.

If (in this example) user 42 selects email button 220, user 42 may define an email address for user 42 within email field 224 (as shown in FIG. 3E) to which confirmation email message 226 may be provided 120 upon user 42 selecting next button 206.

If (in this example) user 42 selects cell phone button 222, user 42 may define a cell phone number for cell phone 228 (as shown in FIG. 3F) within number field 230 to which confirmation text message 232 may be provided 122 upon user 42 selecting next button 206. Additionally, user interface 202 rendered by registration process 10 may also include location field 234 within which user 42 may define the location of cell phone 228.

Registration process 10 may be configured to determine 124 a location of a device (e.g., cell phone 228) associated with the cell phone number entered into number field 230. Specifically, registration process 10 may query 126 the device (e.g., cell phone 228) associated with the cell phone number entered into number field 230 for location information.

If cell phone 228 is equipped with the necessary GPS hardware/software, cell phone 228 may determine its location via GPS methodologies and provide this location information to registration process 10. Registration process 10 may receive 128, from the device (e.g., cell phone 228) associated with the cell phone number entered into number field 230, this location information that (as discussed above) was derived using GPS location methodologies.

If cell phone 228 is not equipped with the necessary GPS hardware/software, cell phone 228 may determine its location via cell tower triangulation methodologies and provide this location information to registration process 10. Registration process 10 may receive 130, from the device (e.g., cell phone 228) associated with the cell phone number entered into number field 230, this location information that (as discussed above) was derived using triangulation methodologies.

Registration process 10 may be configured to compare the location identified by user 42 in location field 234 with the location information received 128, 130 by registration process 10 from cell phone 228 to confirm that they match.

Registration process 10 may be configured to confirm 132 the authenticity of the purchaser (e.g., user 42) based, at least in part, upon the above-described validating information. As discussed above, this validating information may be provided in the form of an email address (to which confirmation email message 226 may be provided 120) or a cell phone number (to which confirmation text message 232 may be provided 122).

Regardless of whether confirmation email message 226 is provided 120 to user 42 or confirmation text message 232 is provided 122 to user 42, both of confirmation email message 226 and confirmation text message 232 may include confirmation information. Examples of such confirmation information may include but are not limited to a PIN code. Accordingly, upon user 42 receiving confirmation email message 226 or confirmation text message 232, user 42 will now know this PIN code. Assume for illustrative purposes that user 42 chose to receive confirmation text message 232 and the PIN code is 4884.

Upon receiving confirmation text message 232, user 42 may access user interface 202 of registration process 10 and enter the PIN code (e.g., 4884) into confirmation field 234 (as shown in FIG. 3G) and then user 42 may select next button 206. Upon selecting next button 206, registration process 10 may receive 134 a confirmation response (that includes the above-described confirmation information; namely PIN code 4884), thus confirming 132 the authenticity of the purchaser (e.g., user 42) based, at least in part, upon the above-described validating information that was previously provided to user 42 via confirmation text message 232.

Upon confirmation 132, registration process 10 may automatically generate 136 online presence 12 at the domain name requested (e.g., ginaly.co). Automatically generating 136 online presence 12 may include generating 138 a webpage (using e.g., webpage configuration utility 236 (See FIG. 3H) provided by registration process 10). Webpage configuration utility 236 may include one or more fields that allow user 42 to modify their webpage including, but not limited to: name field 238 (e.g., that allows user 42 to name their website); about field 240 (e.g., that allows user 42 to describe their website); and background image selector 242 (e.g., that allows user 42 to select a background image). Once satisfied with their webpage, user 42 may select next button 206.

Automatically generating 136 online presence 12 may further include defining 140 at least one email address for the domain name requested (e.g., ginaly). As discussed above, user 42 may have already defined an email address for online presence 12 (see FIG. 3C) when defining 104 a purchaser of the domain name requested (e.g., ginaly). Additionally, registration process 10 may be configured to allow user 42 to define additional email addresses for online presence 12 (using e.g., email configuration utility 244 (See FIG. 3I) provided by registration process 10), wherein these additional email addresses may be accessible by user 42 via third-party email services (e.g., Gmail, Yahoo Mail).

Registration process 10 may be configured to provide online presence 12 to user 42 for a defined period of time (a trial period) at a reduced cost or at no cost. For example, registration process 10 may define 142 a trial period of two weeks for online presence 12. Accordingly and once configured, registration process 10 may maintain 144 online presence 12 during the two week trial period free of charge. During such time, user 42 may use/promote online presence 12.

Proximate the expiry of the trial period, registration process 10 may determine 146 if the purchaser (user 42) would like to maintain online presence 12 past the trial period. Accordingly, some time prior to the expiry of the trial period, registration process 10 may contact user 42 (e.g., via email, text message, phone bank, etc.) to determine 146 if user 42 wishes to maintain online presence 12. If the purchaser (e.g., user 42) would like to maintain online presence 12, registration process 10 may maintain 148 online presence 12 via a subscription model (e.g., $10/month).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
defining a domain name for purchase;
defining a purchaser for the domain name;
defining a cell phone number for the purchaser;
confirming the authenticity of the purchaser based, at least in part, upon SMS messaging; and
automatically generating an online presence at the domain name.

2. The computer-implemented method of claim 1 wherein confirming the authenticity of the purchaser includes:
providing a confirmation text message to the cell phone number.

3. The computer-implemented method of claim 2 wherein the confirmation text message includes confirmation information.

4. The computer-implemented method of claim 3 wherein confirming the authenticity of the purchaser further includes:
receiving a confirmation response that includes the confirmation information.

5. The computer-implemented method of claim 1 further comprising:
determining if the domain name is available for purchase.

6. The computer-implemented method of claim 1 wherein defining a purchaser for the domain name includes:
defining a first name and a last name for the purchaser.

7. The computer-implemented method of claim 1 wherein automatically generating an online presence at the domain name includes:
generating a webpage at the domain name; and
defining at least one email address for the domain name.

8. A computer program product residing on a computer readable medium having a plurality of instructions stored thereon which, when executed by a processor, cause the processor to perform operations comprising:
defining a domain name for purchase;
defining a purchaser for the domain name;
defining a cell phone number for the purchaser;
confirming the authenticity of the purchaser based, at least in part, upon SMS messaging; and
automatically generating an online presence at the domain name.

9. The computer program product of claim 8 wherein confirming the authenticity of the purchaser includes:
providing a confirmation text message to the cell phone number.

10. The computer program product of claim 9 wherein the confirmation text message includes confirmation information.

11. The computer program product of claim 10 wherein confirming the authenticity of the purchaser further includes:
receiving a confirmation response that includes the confirmation information.

12. The computer program product of claim 8 further comprising instructions for:
determining if the domain name is available for purchase.

13. The computer program product of claim 8 wherein defining a purchaser for the domain name includes:
defining a first name and a last name for the purchaser.

14. The computer program product of claim 8 wherein automatically generating an online presence at the domain name includes:
generating a webpage at the domain name; and
defining at least one email address for the domain name.

15. A computing system including a processor and memory configured to perform operations comprising:
defining a domain name for purchase;
defining a purchaser for the domain name;
defining a cell phone number for the purchaser;
confirming the authenticity of the purchaser based, at least in part, upon SMS messaging; and
automatically generating an online presence at the domain name.

16. The computing system of claim 15 wherein confirming the authenticity of the purchaser includes:
providing a confirmation text message to the cell phone number.

17. The computing system of claim 16 wherein the confirmation text message includes confirmation information.

18. The computing system of claim 17 wherein confirming the authenticity of the purchaser further includes:
receiving a confirmation response that includes the confirmation information.

19. The computing system of claim 15 further configured to perform operations comprising:
determining if the domain name is available for purchase.

20. The computing system of claim 15 wherein defining a purchaser for the domain name includes:
defining a first name and a last name for the purchaser.

21. The computing system of claim 15 wherein automatically generating an online presence at the domain name includes:
generating a webpage at the domain name; and
defining at least one email address for the domain name.
